(19) United States
(12) Patent Application Publication
(10) Pub. No.: US 2008/0181525 A1
(43) Pub. Date: Jul. 31, 2008

(54) Image evaluation method, apparatus, and program

(75) Inventors: Shunichiro Nonaka, Asaka-shi (JP); Yousuke Shirahata, Kawasaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,897

(22) Filed: Sep. 26, 2007

(30) Foreign Application Priority Data
Sep. 27, 2006 (JP) 261859/2006

(51) Int. Cl. G06K 9/40

(52) U.S. Cl. 382/254

(57) ABSTRACT

A method and apparatus capable of efficiently calculating evaluation values by reducing the processing time when performing image evaluation. When a processing target image for evaluation is specified, in order to calculate a comparative characteristic amount obtainable by comparing the processing target image with another image, a CPU determines whether or not the another image is tentatively stored in a cache. If the another image is stored in the cache, an individual evaluation value calculation unit calculates the comparative characteristic amount using the image stored in the cache, and calculates an individual evaluation value from the comparative characteristic amount. Then, an overall evaluation value calculation unit calculates an overall evaluation value based on a plurality of individual evaluation values, including the individual evaluation value calculated from the comparative characteristic amount.

### BACKGROUND OF THE INVENTION

1. Field of the Invention

The present invention relates to an image evaluation apparatus and method. It also relates to a program for causing a computer to execute the image evaluation method.

2. Description of the Related Art

Recently, the wide spread use of digital cameras, along with a dramatic increase in the capacity of image recording media, has made it possible for users of digital cameras to record a large number of images on a single image recording medium. At the same time, this has caused the users troublesome efforts to select images to be processed from a huge number of images when, for example, placing a print order or the like. As such, in order to allow the users to efficiently select images, a function to make a short list of images based on certain conditions before the final decision for printing is made by the user or a function to select appropriate images for printing according to user preference is demanded.

For example, Japanese Unexamined Patent Publication No. 2000-137791 proposes a method for evaluating a plurality of images using the focus, amount of exposure, amount of image shake, size and contrast of subject, and the like, and displaying the images in the order of the ranking. Further, Japanese Unexamined Patent Publication No. 2002-010179 discloses a method for automatically selecting an appropriate image for printing using the evaluation value of any of image brightness, acceleration sensor output of the camera, and AF evaluation as the reference. According to these methods, the users may select high-ranked images in the evaluation as appropriate images for printing, so that the burden on the users may be reduced.

Here, when performing the image evaluation, however, it is necessary to read out an image to be evaluated from a recording medium or the like, to calculate individual evaluation values for the focus, amount of exposure, amount of image shake, size and contrast of subject, and to calculate the overall evaluation value using the individual evaluation values for each of the images to be evaluated. In particular, it requires an extended time to read out an image to be evaluated, so that the aforementioned methods are not efficient when calculating the evaluation values for a plurality of images.

### SUMMARY OF THE INVENTION

The present invention has been developed in view of the circumstances described above, and it is an object of the present invention to enable efficient calculation of evaluation values by reducing the processing time when performing image evaluation.

The image evaluation apparatus of the present invention is an apparatus including:

a temporary storage means having a cache function for temporarily storing a processing target image read out from a storage means storing the image;

an individual evaluation value calculation means for calculating a plurality of different types of characteristic amounts included in the processing target image, including a comparative characteristic amount obtainable in comparison with another image which is different from the processing target image, and calculating a plurality of different types of individual evaluation values, each corresponding to each of the plurality of different types of characteristic amounts; and

an overall evaluation value calculation means for calculating an overall evaluation value of the processing target image, which is a comprehensive evaluation value thereof, based on the plurality of different types of individual evaluation values calculated by the individual evaluation value calculation means,

wherein, if the another image, which is a comparison target image for calculating the comparative characteristic amount of the processing target image, is stored in the temporary storage means, the individual evaluation value calculation means calculates the comparative characteristic amount using the another image stored in the temporary storage means.

The referent of “storage means” as used herein means a storage means having a large capacity with a comparatively low readout speed. More specifically, it may be a hard disk, which is a magnetic recording medium that magnetically records information.

The referent of “temporary storage means” as used herein means a storage means having a small capacity but allowing high-speed reading, which is used for temporarily storing a portion of data stored in a storage means having a low data readout speed, such as a hard disk or the like. If data are temporarily stored in such a temporary storage means, the data readout speed may be remarkably increased when a data readout request is received, since the data need not be read out from the hard disk.

The image evaluation method of the present invention is a method including the steps of:

calculating a plurality of different types of characteristic amounts included in a processing target image read out from a storage means storing the image, including a comparative characteristic amount obtainable in comparison with another image which is different from the processing target image;

calculating a plurality of different types of individual evaluation values, each corresponding to each of the plurality of different types of characteristic amounts; and

calculating an overall evaluation value of the processing target image, which is a comprehensive evaluation value thereof, based on the plurality of different types of individual evaluation values,

wherein, if the another image, which is a comparison target image for calculating the comparative characteristic amount of the processing target image, is stored in a temporary storage means having a cache function for temporarily storing a plurality of images, the comparative characteristic amount is calculated using the another image stored in the temporary storage means.

Note that the image evaluation method of the present invention may be provided in the form of a program for causing a computer to execute the method.

According to the present invention, a plurality of different types of characteristic amounts included in a processing target image read out from a storage means storing the image is calculated, including a comparative characteristic amount obtainable in comparison with another image, which is different from the processing target image, and a plurality of different types of individual evaluation values, each corresponding to each of the plurality of different types of characteristic amounts, is calculated, then the overall evaluation value of the processing target image is calculated. Here, if the another image, which is a comparison target image for calculating the comparative characteristic amount of the processing target image, is stored in a temporary storage means, the another image stored in the temporary storage is read out to calculate the comparative characteristic amount, and the individual evaluation value is calculated. Thus, if the another image, which is a comparison target image for calculating the comparative characteristic amount, is stored in the temporary storage means, the time required for reading out the another image may be reduced. This reduces the processing time for the calculation of evaluation values, thereby the evaluation values may be calculated efficiently.

### BRIEF DESCRIPTION OF THE DRAWINGS

FIG. 1 is a schematic block diagram of an image evaluation apparatus according to an embodiment of the present invention, illustrating the construction thereof.

FIG. 2 is a flowchart illustrating a process performed in the embodiment.

### DESCRIPTION OF THE PREFERRED EMBODIMENTS

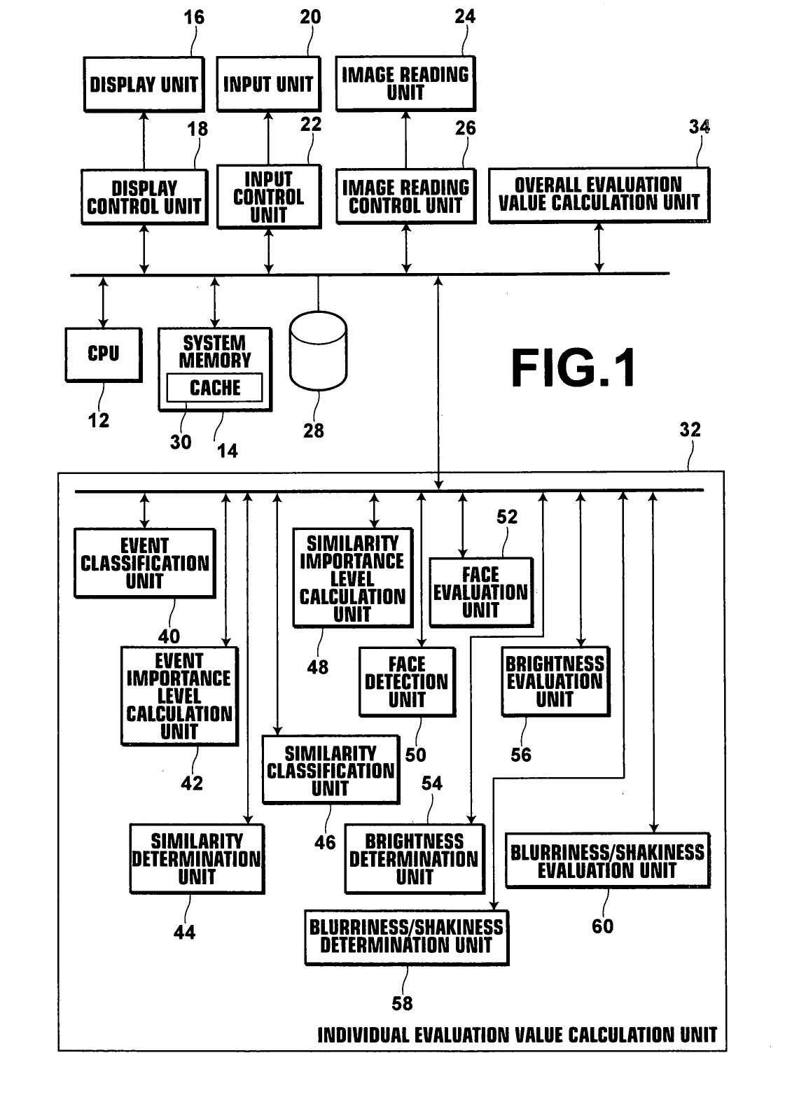

Hereinafter, an exemplary embodiment of the present invention will be described with reference to the accompanying drawings. FIG. 1 is a schematic block diagram of an image evaluation apparatus according to an embodiment of the present invention, illustrating the construction thereof. As illustrated in FIG. 1, the image evaluation apparatus 1 of the present embodiment includes: a CPU 12 that performs various control operations on image data, including record and display control operations, as well as controlling each unit of the image evaluation apparatus 1; a system memory 14 that includes a ROM having therein a program for causing the CPU 12 to operate, viewer software for viewing images, and various constants, and a RAM serving as a work area for the CPU 12 when performing processing; a display unit 16 that includes, for example, a liquid crystal display for performing various display operations; a display control unit 18 that controls the display unit 16; an input unit 20 that includes a keyboard, mouse, touch panel, and the like for giving instructions and performing various input operations to the apparatus 1; and an input control unit 22 that controls the input unit 20. Note that a certain area of the RAM of the system memory 14 serves as a cache 30 for tentatively storing a target image for calculating an evaluation value or the like.

The image evaluation apparatus 1 further includes: an image reading unit 24 that reads out image data from a recording medium, such as a memory card having thereon image data representing an image or the like, or records image data on a recording medium; an image reading control unit 26 that controls the image reading unit 24; and a hard disk 28 for storing various types of information, including image data.

Image data read in by the image reading unit 24 are stored in the hard disk 28. When performing a process for calculating an evaluation value to be describe later, a processing target image is read out from the hard disk 28, tentatively stored in the cache 30, and the process for calculating an evaluation value is performed thereon. The cache 30 tentatively stores a number of images according to the memory capacity. For example, if the file size of the image is 1 MB, and the memory capacity of the cache 30 is 3 MB, then three images are tentatively stored in the cache 30. When a new image is read out, it is stored in the cache 30 in place of the least recent image.

The image evaluation apparatus 1 further includes: an individual evaluation value calculation unit 32 that calculates, when a processing target image and an evaluation item are specified by an operator using the input unit 20, the evaluation value of the evaluation item of the processing target image (individual evaluation value); and an overall evaluation value calculation unit 34 that calculates an overall evaluation value of the processing target image based on the individual evaluation value calculated by the individual evaluation value calculation unit 32.

The individual evaluation value calculation unit 32 includes: an event classification unit 40 that classifies a plurality of images read in by the image reading unit 24 into a plurality of groups with respect to each event, and calculates information indicating to which group each image belongs as one of the characteristic amounts of the images; an event importance level calculation unit 42 that calculates an event importance level, which is the importance level of each of the plurality of event groups classified by the event classification unit 40, as one of the individual evaluation values of each image classified into each group; a similarity determination unit 44 that calculates a similarity level between the plurality of images read in by the image reading unit 24 as one of characteristic amounts of the images; a similarity classification unit 46 that classifies the images into a plurality of similar image groups based on the similarity level calculated by the similarity determination unit 44, and calculates information indicating to which group each image belongs as one of characteristic amounts of the images; and a similarity importance level calculation unit 48 that calculates a similarity importance level, which is the importance level of each of the plurality of groups classified by the similarity classification unit 46 as one of the individual evaluation values of each image classified into each group.

The event classification unit 40 classifies a plurality of images into a plurality of groups with respect to each event, which is a set of images obtained with a bunch of intentions. More specifically, the event classification unit 40 classifies a plurality of images into a plurality of groups with respect to each event using a method in which the plurality of images is sorted by imaging date and time, and between two images where imaging time difference is greater than a predetermined value is determined to be the delimiting position between two events. Note that the method for classifying a plurality of images into a plurality of groups with respect to each event is not limited to the method described above and various methods may be used, including a method in which a single imaging location is deemed to be a single event, and images are classified into a plurality of groups with respect to each imaging location using imaging location information attached to the images.

The event importance level calculation unit 42 calculates an event importance level as one of the individual evaluation values using a method that calculates the importance level of each group based on information of the number of images included in each group, and the number of groups related to each group, as described, for example, in Japanese Unexamined Patent Publication No. 2006-171942.

The similarity importance level calculation unit 48 calculates a similarity importance level as one of the individual evaluation values using a method that further generates similar image groups within each group including similar images, and setting an importance level to each group according to the number of similar image groups and/or the number of images included in the similar image groups within each group. Note that a similarity determination target image is required as well as a processing target image in order to calculate the similarity importance level.

The individual evaluation value calculation unit 32 further includes: a face detection unit 50 that detects a face from a processing target image, and calculates at least one of the face size, position, orientation, rotational angle of the detected face on the image, and face detection score as a characteristic amount; and a face evaluation unit 52 that calculates an evaluation value based on the characteristic amount calculated by the face detection unit 50 as one of the individual evaluation values.

The individual evaluation value calculation unit 32 further includes: a brightness determination unit 54 for calculating the brightness of a processing target image (e.g., average pixel value of all of the pixels of the image); and a brightness evaluation unit 56 for calculating an evaluation value based on the brightness of the processing target image as one of the individual evaluation values based on the brightness of the image calculated by the brightness determination unit 54.

The individual evaluation value calculation unit 32 further includes: a blurriness/shakiness determination unit 58 that calculates information indicating the degree of blurriness and shakiness of a processing target image as one of the characteristic amounts of the image; and a blurriness/shakiness evaluation unit 60 that calculates an evaluation value based on the characteristic amount calculated by the blurriness/shakiness determination unit 58 as one of the individual evaluation values. Note that an image with a less amount of high frequency component has a greater amount of blurriness/shakiness, so that a method that calculates a value inversely proportional to the amount of high frequency component may be used for the calculation of the information indicating the degree of blurriness and shakiness.

The individual evaluation value calculation unit 32 may include a means for calculating another characteristic amount included in an image and calculating an individual evaluation value based on the calculated characteristic amount, other than the aforementioned event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60.

Further, the individual evaluation value calculation unit 32 does not necessarily include all of the aforementioned units, namely, the event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60. The individual evaluation value calculation unit 32 may be a unit that includes some of them, for example, the face detection unit 50, face evaluation unit 52, brightness determination unit 54, and brightness evaluation unit 56.

Still further, the individual evaluation value calculation unit 32 includes the aforementioned event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60, so that it may calculate an event importance level, similarity image importance level, face evaluation value, brightness evaluation value, and blurriness/shakiness evaluation value as individual evaluation values for a processing target image. But an arrangement may be adopted in which individual evaluation values for only the evaluation items specified by an operator through the input unit 20 are calculated. For example, if it is indicated that image evaluation be performed based on the event importance level, face evaluation value, and brightness evaluation value by the operator as evaluation items through the input unit 20, the individual evaluation value calculation unit 32 calculates only the event importance level, face evaluation value, and brightness evaluation value.

Further, an arrangement may be adopted in which the event importance level calculation unit 42, similarity importance level calculation unit 48, face evaluation unit 52, brightness evaluation unit 56, and blurriness/shakiness evaluation unit 60 calculate individual evaluation values according to intended use of the evaluation target image (e.g., selecting images for an album or present, or the like), user age group of the evaluation target image (e.g., selecting images from the viewpoints of grandparents or children), user preference of the evaluation target image, and the like. In this case, by inputting an evaluation parameter for weighting characteristic amounts according to intended use of the evaluation target image, user age group, user preference, and the like (evaluation purpose) through the input unit 20 or providing in advance, individual evaluation values may be calculated by weighting the characteristic amounts according to the evaluation purpose.

For example, in the face evaluation unit 52, an evaluation value based on the information of at least one of the face size, position, orientation, rotational angle of the face on the image, and face detection score detected by the face detection unit 50 is calculated as an individual evaluation value. But, these information items vary in importance according to the evaluation purpose. Accordingly, by calculating individual evaluation value after weighting these information items using an evaluation parameter for weighting characteristic amounts according to the evaluation purpose, an evaluation value according to the evaluation purpose may be calculated. For this purpose, in the present embodiment, the evaluation may sometimes be performed a plurality of times on a single image, depending on the evaluation purpose. Therefore, there may be a case in which a single image has different individual evaluation values, and hence different overall evaluation values depending on the evaluation purpose.

The overall evaluation value calculation unit 34 calculates the overall evaluation value by performing a weighted addition of the individual evaluation values calculated by the individual evaluation value calculation unit 32. The weighting factors of the individual evaluation values may be set according to the evaluation purpose as in the calculation of the individual evaluation values.

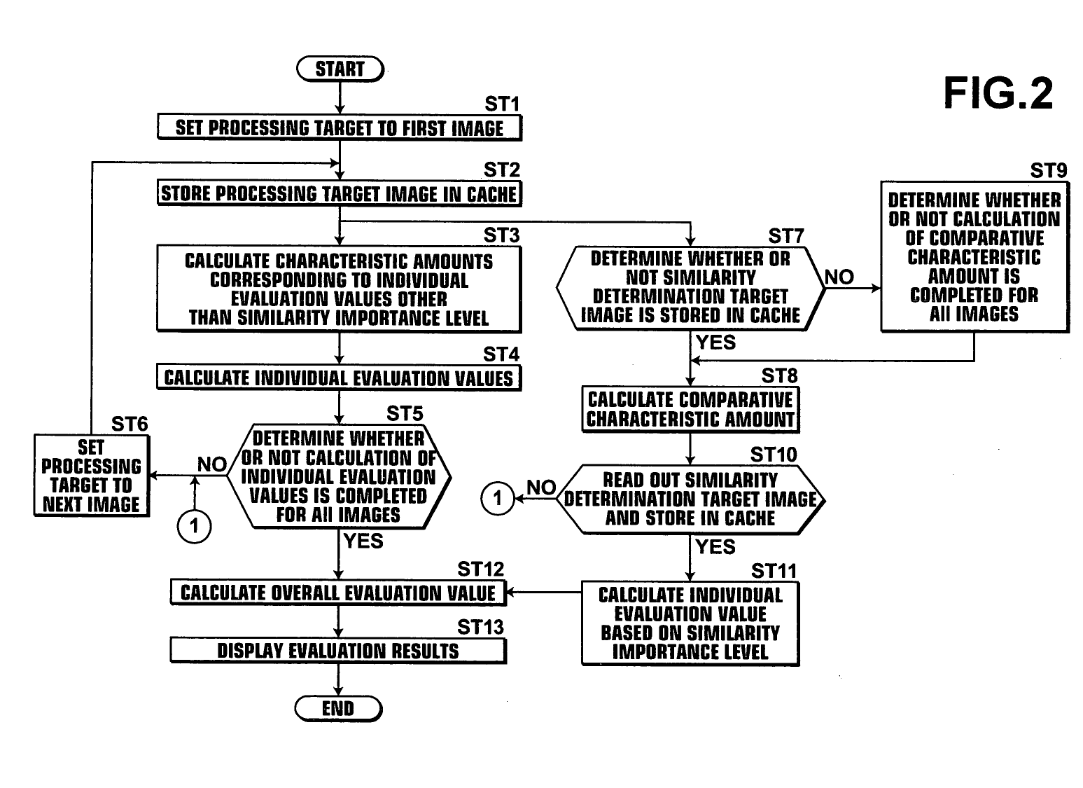

Next, a process performed in the present embodiment will be described. FIG. 2 is a flowchart illustrating the process performed in the present embodiment. In the present embodiment, it is assumed that images read in by the image reading unit 24 are stored in the hard disk 28. Further, the present embodiment includes individual evaluation value based on the similarity importance level as an evaluation item. When a plurality of images, an evaluation item, and an evaluation purpose are specified by an operator through the input unit 20, the CPU 12 initiates the process. First, the CPU 12 sets the processing target to the first image (e.g., leading image when the images are sorted by file name) (step ST1), and the individual evaluation value calculation section 32 reads out the processing target image from the hard disk 28 and stores in the cache 30 (step ST2).

The specification of the image may be performed by entering the file name, or displaying an image list on the display unit 16 and selecting the image from the list. The evaluation item or evaluation purpose may be specified by directly entering the type thereof through the input unit 20, or entering a predetermined symbol corresponding to each of the evaluation items or evaluation purposes. Alternatively, the evaluation item or evaluation purpose may be selected from a list of evaluation items or evaluation purposes displayed on the display unit 16.

Then, for the image stored in the cache 30, the individual evaluation value calculation unit 32 calculates characteristic amounts corresponding to the individual evaluation values of the specified evaluation items other than the individual evaluation value, which bases on the similarity importance level (individual evaluation values other than similarity importance level) (step ST3), and calculates the individual evaluation values based on the calculated characteristic amounts (step ST4).

For example, if the individual evaluation values are face evaluation value and image brightness evaluation value, the face detection unit 50 calculates the characteristics of the face, and the brightness determination unit 54 calculates the brightness of the image as the characteristic amounts, and the face evaluation unit 52 and brightness evaluation unit 56 calculate the evaluation value of the face and evaluation value of the brightness respectively as the individual evaluation values.

Then, the individual evaluation value calculation unit 32 determines whether or not the calculation of the individual evaluation values is completed for all of the images specified by the operator (step ST5). If step ST5 is negative, the individual evaluation value calculation unit 32 sets the processing target to the next image (step ST6), and returns to step ST2 to repeat the processing from step ST2 onward.

In the mean time, the individual evaluation value calculation unit 32 determines whether or not a similarity determination target image, which is a comparison target image for similarity determination with the processing target image, is stored in the cache 30 in parallel with steps ST3 to ST6 (step ST7). If step ST7 is positive, the similarity determination unit 44 and similarity classification unit 46 of the individual evaluation value calculation unit 32 calculate the characteristic amount corresponding to the individual evaluation value based on the similarity importance level (i.e., information indicating to which groups the images are classified, which is hereinafter referred to as “comparative characteristic amount”) for the processing target image and similarity determination target image stored in the cache 30 (step ST8).

On the other hand, if step ST7 is negative, the individual evaluation value calculation unit 32 proceeds to step ST8 after reading out a similarity determination target image from the hard disk 28 and stores in the cache 30 (step ST9). Then, the individual evaluation value calculation unit 32 determines whether or not the comparative characteristic amounts are calculated for all of the images (step ST10), and if step ST10 is negative, it returns to step ST6. If step ST10 is positive, the similarity importance level calculation unit 48 calculates the similarity importance level of each of a plurality of groups classified by the similarity classification unit 46 as an individual evaluation value of each image classified into each of the groups (individual evaluation value based on the similarity importance level) (step ST11). This completes the calculation of the individual evaluation value based on the similarity importance level for each of the images specified by the operator.

When step ST5 is positive, or following the step ST11, the overall evaluation value calculation unit 34 calculates the overall evaluation value for each of the images by performing a weighted addition of the individual evaluation values (step ST12), and the CPU 12 causes the display unit 16 to display a list of images together with the calculated overall evaluation values as evaluation results (step ST13), thereafter the process is terminated.

The operator may select a highly evaluated image based on the list of images and overall evaluation values displayed on the display unit 16, and print the selected image or record the image on a recording medium.

Here, an arrangement may be made in which, when displaying the list of image on the display unit 16, a predetermined number of images having high overall evaluation values are displayed in enlarged form as recommended images for printing and the like, since such images are successfully photographed images. This allows the operator to easily select images suitable for printing and the like.

As described above, when calculating the individual evaluation value based on the similarity importance level, if a similarity determination image is stored in the cache 30, the individual evaluation value is calculated using the image stored in the cache 30 in the present embodiment, so that the time required for reading out a similarity determination image may be reduced if it is stored in the cache 30. This may reduce the processing time required for calculating evaluation values, thus, the evaluation values may be calculated efficiently.

In the present embodiment, a certain area of the system memory 14 is used as the cache 30, but it may be provided in the CPU 12 or on the hard disk 28.

So far, the apparatus 1 according to an embodiment of the present invention has been described. A program for causing a computer to function as the means corresponding to the individual evaluation value calculation unit 32 and overall evaluation value calculation unit 34, thereby causing the computer to execute the process like that illustrated in FIG. 2 is another embodiment of the present invention. Further, a computer readable recording medium on which such a program is recorded is still another embodiment of the present invention.

What is claimed is:

1. An image evaluation apparatus, comprising:
a temporary storage means having a cache function for temporarily storing a processing target image read out from a storage means storing the image;
an individual evaluation value calculation means for calculating a plurality of different types of characteristic amounts included in the processing target image, including a comparative characteristic amount obtainable in comparison with another image, which is different from the processing target image, and calculating a plurality of different types of individual evaluation values, each corresponding to each of the plurality of different types of characteristic amounts; and
an overall evaluation value calculation means for calculating an overall evaluation value of the processing target image, which is a comprehensive evaluation value thereof, based on the plurality of different types of individual evaluation values calculated by the individual evaluation value calculation means,
wherein, if the another image, which is a comparison target image for calculating the comparative characteristic amount of the processing target image, is stored in the temporary storage means, the individual evaluation value calculation means calculates the comparative characteristic amount using the another image stored in the temporary storage means.

2. The image evaluation apparatus according to claim 1, wherein the storage means is a storage means having a large capacity with a comparative low readout speed, and the temporary storage means is a means having a small capacity and allowing high-speed reading.

3. An image evaluation method, comprising the steps of:
calculating a plurality of different types of characteristic amounts included in a processing target image read out from a storage means storing the image, including a comparative characteristic amount obtainable in comparison with another image which is different from the processing target image;
calculating a plurality of different types of individual evaluation values, each corresponding to each of the plurality of different types of characteristic amounts; and
calculating an overall evaluation value of the processing target image, which is a comprehensive evaluation value thereof, based on the plurality of different types of individual evaluation values,
wherein, if the another image, which is a comparison target image for calculating the comparative characteristic amount of the processing target image, is stored in a temporary storage means having a cache function for temporarily storing a plurality of images, the comparative characteristic amount is calculated using the another image stored in the temporary storage means.

4. A program for causing a computer to perform an image evaluation method comprising the steps of:
calculating a plurality of different types of characteristic amounts included in a processing target image read out from a storage means storing the image, including a comparative characteristic amount obtainable in comparison with another image which is different from the processing target image;
calculating a plurality of different types of individual evaluation values, each corresponding to each of the plurality of different types of characteristic amounts; and
calculating an overall evaluation value of the processing target image, which is a comprehensive evaluation value thereof, based on the plurality of different types of individual evaluation values,
wherein, if the another image, which is a comparison target image for calculating the comparative characteristic amount of the processing target image, is stored in a temporary storage means having a cache function for temporarily storing a plurality of images, the comparative characteristic amount is calculated using the another image stored in the temporary storage means.
